(19) United States
(12) Patent Application Publication
(10) Pub. No.: US 2014/0125530 A1
(43) Pub. Date: May 8, 2014

(54) Compact Mobile and Fixed Broadband Dual-Mode HF Antenna System

(71) Applicant: OMEGA-TEC, LLC, Canton, MS (US)

(72) Inventors: Willie K. Bolick, Madison, MS (US); Tom C. Brown, Madison, MS (US); Erik M. Williamsen, Canton, MS (US); Christopher E Frantz, madison, MS (US)

(73) Assignee: Omega-Tec, LLC, Canton, MS (US)

(21) Appl. No.: 13/669,538

(22) Filed: Nov. 6, 2012

(51) Int. Cl. H01Q 5/00; H01Q 1/27

(52) U.S. Cl. CPC H01Q 5/001; H01Q 1/27
USPC 343/713; 343/745; 343/700 R

(57) ABSTRACT

The Omega-Tec Compact Mobile and Fixed Broadband Dual-Mode HF Antenna System represented is a Dual-Mode HF Mobile Antenna System composed of two subsystems. The low band unit provides NVIS high-angle communications over an operating frequency range of 2-10 MHz while the high band unit provides conventional low-angle long range communications over a frequency range of 8-30 MHz.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The Omega-Tec Compact Mobile and Fixed Broadband Dual-Mode HF Antenna System is designed to fill the need for a compact, rugged, versatile HF antenna for vehicle-mounted mobile use and fixed building mounting where space is an issue. The antenna is intended to be used while the vehicle is either stationary or in motion. The need is for an antenna that has a built in auto-tuner located within the main antenna assembly.

The Compact Mobile and Fixed Broadband Dual-Mode HF Antenna System is primarily intended for mobile and fixed HF communications including voice, data and CW via skywave propagation (NVIS, single-hope or multi-hop). Depending on propagation conditions that exist at the time, this range could encompass distances of well beyond 5000 miles all the way down to the point where direct line-of-sight propagation becomes dominant.

The entire antenna assembly is intended to be mounted on the roof of a building or metal skinned vehicle with the radiator assembly's axis perpendicular to the front to back axis of the vehicle.

The base of the antenna is designed to be bolted to the roof of the vehicle which puts the radiator assembly at a height of (nominally) 18 inches above the vehicle's roof.

### SUMMARY OF THE INVENTION

The antenna is designed and intended for use while the vehicle is either stationary or in motion.

Since the antenna's radiator assembly is rigid and fixed in position, there should be no significant difference in performance between operating while the vehicle is in motion and operating while the vehicle is stationary. Although the antenna covers a nominal frequency range of 2 MHz to 30 MHz, the total height above the vehicle's roof is nominally only 18 inches, at all times (even while in use). There is no reason whatsoever to leave the vehicle to prepare the antenna for operation, to secure the antenna after use or while the antenna is in operation.

The unit accepts a maximum RF input power of 1000 watts ICAS. It is suitable for use in voice, data and CW modes.

Unlike vertical whip antennas, this unit radiates well at a variety of takeoff angles from high to low and is therefore particularly well suited for a wide variety of uses including NVIS (short range on lower frequencies) and low-angle, long range (higher frequencies). An added benefit of the unique radiator design is the fact that no change in geometry is required or even advisable when switching from a low angle path (hundreds to thousands of miles circuit length) to a high angle NVIS path (near local circuit).

Omega-Tec's primary target in developing this particular mobile antenna is improvement with respect to the standard vertical whip that is in very common use. In order for a whip to be used for NVIS communications over a relatively short path, the standard procedure is for the radio operator to get out of the vehicle and bend the whip over to a predominantly horizontal orientation and tie the end of the whip down to hold it in place. In order to change once again, to longer range communications, the operator must once again get out of the vehicle and release the tie-down on the whip and allow it to return to its normal, vertical orientation. In many environments, this can be a potential problem for the operator and Omega-Tec has sought to develop an antenna that would offer outstanding performance in both NVIS and long range mode without having to change its orientation or provide any operator intervention at all.

### BRIEF DESCRIPTION OF THE DRAWINGS

FIG. 1 is a side view of a Dual-Mode HF Antenna System of the present invention;

FIG. 2 is an end view of a tuner end of the Dual-Mode HF Antenna System;

FIG. 3 is a bottom view of a base section of the Dual-Mode HF Antenna System;

FIG. 4 is a top view of the assembled NVIS Antenna System of the Dual-Mode HF Antenna System;

FIG. 5 is a perspective view of the power connectors of the Dual-Mode HF Antenna System;

FIG. 6 is a perspective view of a Dual-Mode HF Antenna System;

FIG. 7 is a perspective view of a Dual-Mode HF Antenna auto tuner section;

### DETAILED DESCRIPTION OF THE INVENTION

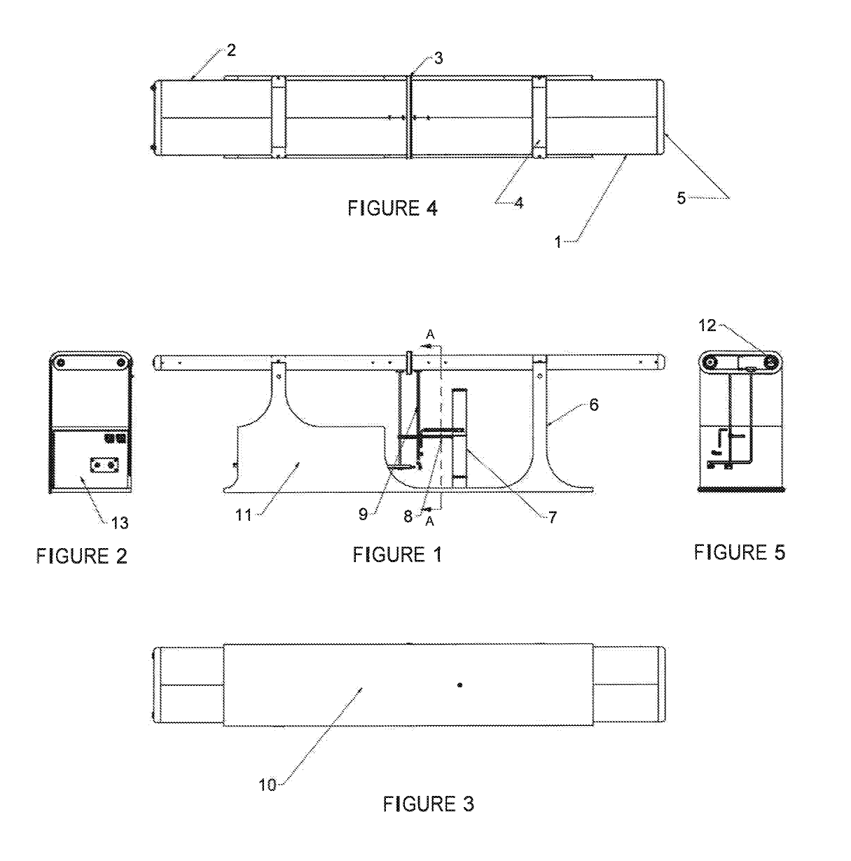

The HF antenna system represented is a Dual-Mode Mobile Antenna System composed of two subsystems. Referring now to the invention shown in FIGS. 1 and 4 the low band unit 1 provides NVIS high-angle communications over an operating frequency range of 2-10 MHz while the high band unit 7 provides conventional long range communications over a frequency range of 8-30 MHz. At the heart of both of these subsystems is a proprietary technology which provides “large antenna” performance while keeping the radiator assembly very small. The use of this technology allows greater radiation efficiency combined with greater instantaneous bandwidth than would be possible with small loops and other competing designs.

In more detail, still referring to the invention of FIGS. 1 and 4 the key to this concept is in the precise relationships that exist between the size and proximity 6 and 11 of the various sections of the radiator assemblies. In more detail, still referring to the invention of FIG. 4 one facet of the concept is that a very high RF voltage field is developed between adjacent sections 1 and 2 of the radiator assemblies, unlike the high current field that would normally be found in that section of a conventional antenna. Referring now to the invention shown in FIG. 7 the principal tuning element 16 of the system is a very robust roller inductor that is employed in an unconventional manner. It is under the fully automatic control 21 of an electronic tuning control unit that keeps the system in resonance no matter where the chosen operating frequency is (within the 1.7-30 MHz range of the unit). At 3:1 SWR the available bandwidth ranges from 260 KHz@8-30 MHz to 30 KHz@2 to 10 MHz. Unlike vertical whip antennas, this unit radiates as well at high takeoff angles as it does at low takeoff angles and is therefore equally well suited for use in NVIS communications which is normally a problem for a standard vertical whip.

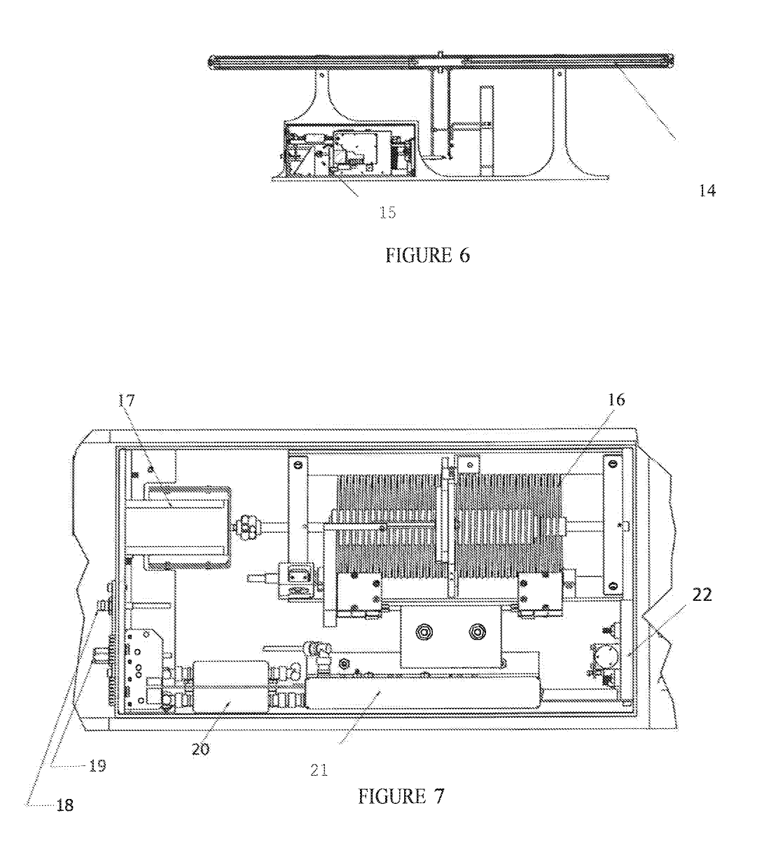

Referring now to the invention shown in FIG. 6 this antenna system 14 and 15 is primarily intended for mobile HF communications including voice, data and CW over a very wide range of distances that includes the short range which would normally be associated with “one hop” ionospheric propagation and the longer range circuits that would normally be associated with multi-hop ionospheric propagation. Depending on propagation conditions that exist at the time, this range could encompass distances of well beyond 5000 miles all the way down to the point where direct line-of-sight propagation becomes dominant.

Referring now to the invention shown in FIGS. 3 and 4 the Method of Intended Deployment is to mount the unit on the roof of a metal skinned vehicle with the radiator assembly's axis perpendicular to the front to back axis of the vehicle. The base of the antenna is designed to be bolted to the roof of the vehicle which puts the radiator assembly at a height of (nominally) 18 inches above the vehicle's roof.

Referring now to the invention shown in FIG. 7 the tuning is accomplished by a self-contained automatic tuning control unit 17, 20, 21, and 22 while the operator remains safely inside of the cab of the vehicle.

In more detail, still referring to the invention of FIG. 1 an added benefit of the unique radiator 7 design is the fact that no change in geometry is required or even advisable when switching from a low angle path (hundreds of miles circuit length) to a high angle NVIS path (near local circuit).

The antenna is designed and intended for use while the vehicle is either stationary or in motion.

Since the antenna's radiator assembly is rigid and fixed in position 10, 12, and 13, there should be no significant difference in performance between operating while the vehicle is in motion and operating while the vehicle is stationary. Referring now to the invention shown in FIGS. 1, 2, and 5 although the antenna covers a nominal frequency range of 2 MHz to 30 MHz, the total height above the vehicle's roof is only 18 inches, at all times.

There is no reason to leave the vehicle while the antenna is in operation.

The antenna developer has sought to develop an antenna that would function well in NVIS mode without having to change its orientation, while keeping NVIS RF performance equal to or better than the standard whip where the standard procedure is for the radio operator to get out of the vehicle and bend the whip over to a predominantly horizontal orientation and tie the end of the whip down to hold it in place.

HF antenna specifications are as follows: a single (NVIS) antenna provides minimum of 130-200 kHz bandwidth allowing for current configuration of (32 carriers) each 3 kHz channels allowing ˜300 kbps data rate.
Available Power: 15-50 Watts with Ranges from ˜2 NM to ˜1000 NM
A Smart Tuner FIG. 7 allows for continuous up time shifting from one frequency to the most advantageous frequency available during the transmit and or receive period at a lower power. This allow for 24×7 up time (to be demonstrated)
   Configuration is for mobile vehicular, shipboard and aircraft versions.
Total Frequency Coverage: 2-30 MHz
Bands Covered: 2
   Band 1: 2-10 MHz (NVIS—Local to 600 miles)
   Band 2: 8-30 MHz (Low angle—Long Distance)
Polarization:
   Band 1 (2-10 MHz) Horizontal
   Band 2 (8-30 MHz) Vertical
RF Input Power Limit: 1000 watts ICAS 18, 19
RF Input Power Requirement for Automatic Operation: 3 watts minimum 20 watts max
VSWR at Operating Frequency: Better than 2:1 at any operating frequency
Tuning Method: Fully automatic, internal tuning unit
Bandswitching Method: Fully automatic
Power requirements:
   12-28 VDC at 3 A
Length: 6.25′ Nominal
Height above vehicle: 18″-24″ (depending on final design) FIG. 1.

1. Dual-Mode HF Mobile Antenna System composed of two subsystems consisting of the Low band and High band. The Low band unit provides NVIS high-angle communications, and the High band unit provides conventional long range low-angle communications.

2. From claim 1 the low band unit provides NVIS high-angle communications over an operating frequency range of 2-10 MHz.

3. From claim 1 the high band unit provides conventional long range low-angle communications over a frequency range of 8-30 MHz.

4. Maximum RF input power of 1000 watts ICAS

5. Auto-tuner located within the main antenna assembly.

6. From claim 5 the principal tuning element, a robust roller inductor is under the automatic control of an electronic tuning control unit that keeps the system in resonance.

7. The radiator assemblies are made of formed sheet metal.

8. From claim 7 the ends of the radiators press against the center insulator and are open with no plates covering them.

9. From claim 7 the threaded rods that protrude slightly from the ends of the radiators hold the radiator fast creating a single unit.

10. From claim 7 the Low band unit radiators are constructed in an oval racetrack shape (cross section) with round reinforcement rods inserted within.

11. The Frame of the antenna system is constructed in a wing spoiler concept mounted on a set of uprights with a solid base.

12. From claims 7 and 11 the wing and base combination physically measure approximately 21 inches high, 75 inches long, and 12.25 inches wide.

13. From claim 7 the Low band unit radiator is represented by the wing spoiler.

14. From claim 7 the High band unit is a tube like unit approximately 12 inches long and 2.5 inches in diameter.
